(19) United States
(12) Patent Application Publication
(10) Pub. No.: US 2021/0205860 A1
(43) Pub. Date: Jul. 8, 2021

(54) CLEANING CONTAINER FOR CLEANING VALVES OF DOSING FACILITIES AND CORRESPONDING CLEANING METHOD

(71) Applicants: BASF Coatings GmbH, Münster (DE); Fricke Abfuelltechnik GmbH & Co, Minden (DE)

(72) Inventors: Alexander Blaser, Münster (DE); Olaf Oestermann, Bad Salzuflen (DE)

(21) Appl. No.: 17/059,461

(22) PCT Filed: May 28, 2019
(86) PCT No.: PCT/EP2019/063800

§ 371 Date: Nov. 29, 2020

(30) Foreign Application Priority Data
May 29, 2018 (EP) 18174816.1

(51) Int. Cl. B08B 9/032; B08B 5/02; B05B 15/555

(52) U.S. Cl. CPC B08B 9/0323; B08B 9/0328; B08B 2209/032; B05B 15/555; B08B 5/02

(57) ABSTRACT

Described herein is a container suitable for cleaning metering valves of a metering system. The container can be mounted on a metering valve, includes a container opening, a container body, and a container base. The container has at least one nozzle, which is let into the container base, through which the container can be supplied with compressed air and/or through which a cleaning compound can be pumped into the container, and also has at least one outlet let into the container base. Also described herein are a use of the container for cleaning metering valves of a metering system, a metering valve on which a container is mounted, a metering system including at least one such metering valve, and a method for cleaning metering valves of a metering system, wherein the method includes cleaning at least one metering valve of a metering system using at least one container.

The present invention relates to a container (1), which is suitable for cleaning metering valves of a metering system, which container (1) can be mounted on a metering valve (10) and comprises a container opening (1a), a container body (2) and a container base (3), has in its interior at least one nozzle (4), which is let into the container base (3), through which the container (1) can be supplied with compressed air and/or through which a cleaning compound can be pumped into the container (1), and has at least one outlet (5) let into the container base (3), a use of the container (1) for cleaning metering valves of a metering system, a metering valve (10), on which a container (1) is mounted, a metering system comprising at least one such metering valve (10), and a method for cleaning metering valves of a metering system, wherein the method comprises at least one step (1), namely cleaning at least one metering valve of a metering system using at least one container (1).

### PRIOR ART

Coating compositions that can be used in the automotive industry are nowadays produced both on a (large) industrial scale and for development purposes in the laboratory, generally using a metering system suitable for this purpose. In this context, the metering system is usually employed for the production of a large number of coating compositions and precursors thereof that differ chemically and in terms of their use, e.g. electrodeposition coatings, primer surfacers, base coats and top coats, including clear coats and precursors, such as pigment pastes or intermediates in general. Metering systems of this kind used in this sector are generally based on a gravimetric procedure, which makes use of pivotable and fixed valves.

During metering by means of such metering systems, there are inevitably physical drying processes involving the raw materials or raw material mixtures to be metered which are used to produce the coating compositions and precursors thereof. It is therefore essential to clean the valves of such metering systems. If cleaning is not carried out, there will in the long term be adhesions within and also in the external area of the valve openings, especially in the case of quick-drying raw materials. Adhesions within the valve opening lead to blockages within the valve, severely restricting the functioning thereof. Unwanted dried material adhering in the external area of the valve opening and in the valve outlet area can also form when using valves which are closed while unused in order to prevent the raw material to be metered from being in permanent contact with the surrounding atmosphere. Such contamination can lead to unwanted deflection of the metering jet during subsequent metering. As a consequence, further contamination of the environment, e.g. of the balance of a gravimetric metering system, can occur, on the one hand. On the other hand, such dried-on contaminants can lead to incorrect metering, e.g. if the quantity to be metered is not metered fully into the container provided for this purpose but still reaches the balance. If 20 g of 100 g of a quantity of a certain component to be metered do not reach the container but reach the balance, metering is recorded as complete and correct by the metering system but the metering error, which is then not recognized, in respect of this component is in reality 20% by weight.

Cleaning of valves of the metering system is generally based on “strippers” if the valves are pivotable. In this case, the valve is moved over a stripper of this kind, which forms a kind of fixed brush or sponge. In the case of fixed valves, cleaning is generally performed by means of brushes. In this case, the valve is cleaned by means of a rotating brush roller, which is generally wetted with an aqueous rinsing agent. However, the disadvantage of these methods is the risk of possible cross transfer of contaminants via the brushes or the strippers to other valves to be cleaned subsequently since at least some of the contaminants may adhere to the brushes and strippers and these are used multiple times for cleaning additional valves. Moreover, these conventional cleaning methods often fail to give a sufficient cleaning performance.

There is therefore a need for an efficient way of cleaning valves of metering systems which does not have the abovementioned disadvantages, especially in metering systems with a high number of valves.

### Object

It is therefore an object of the present invention to provide a method for cleaning metering valves of metering systems which does not have the abovementioned disadvantages and by means of which it is possible, in particular, to prevent the occurrence of incorrect metering due to unwanted contaminants within the metering valve and in the area of the opening of the metering valve.

### Solution

This object is achieved by the subject matter claimed in the patent claims and by the preferred embodiments of this subject matter which are described in the following description.

A first subject of the present invention is therefore a container (1), which is suitable for cleaning metering valves of a metering system, wherein the container (1) can be mounted on a metering valve (10) and comprises a container body (2) and a container base (3), wherein
the container (1) has in its interior at least one nozzle (4), which is let into the container base (3), through which the container (1) can be supplied with compressed air and/or through which a cleaning compound can be pumped into the container (1), wherein the nozzle (4) is preferably connected to a connecting element (6), which can be removed therefrom and which has both a compressed air connection (6a) and a connection (6b) for connecting a device (7) by means of which a cleaning compound can be pumped into the container (1),
the container (1) has at least one outlet (5) let into the container base (3), and
the container (1) preferably has a container opening (1a), which is designed in such a way that, when the container (1) is mounted on the metering valve (10), at least the head (10a) of the metering valve (10), said head containing the valve opening, is surrounded in flush alignment by the container (1).

A further subject of the present invention is a use of the container (1) according to the invention for cleaning metering valves of a metering system.

A further subject of the present invention is a metering valve (10), on which a container (1) according to the invention for cleaning the metering valve is mounted.

A further subject of the present invention is a metering system comprising at least one metering valve (10), on which a container (1) according to the invention for cleaning the metering valve is mounted.

A further subject of the present invention is a method for cleaning metering valves of a metering system, wherein the method comprises at least one step (1), namely
(1) cleaning at least one metering valve of a metering system using at least one container (1) according to the invention.

It has surprisingly been found that the container (1) according to the invention which is used allows improved cleaning of metering valves of a metering system as compared with conventional cleaning methods.

It has furthermore surprisingly been found that efficient cleaning of metering valves and, in particular, of the heads thereof can be performed by means of the container (1) according to the invention which is used, making it possible to prevent the occurrence of adhering contaminants, such as dried-on material on the metering valve, within the metering valve and in the area of the opening of the metering valve, as a result of which, in turn, it is possible to avoid the occurrence of incorrect metering due to such contaminants, which could otherwise lead to unwanted deflection of the metering jet during subsequent metering.

### DETAILED DESCRIPTION

Container (I) According to the Invention

The container (1) according to the invention can be mounted on the metering valve (10) to be cleaned and comprises a container body (2) and a container base (3), has in its interior at least one nozzle (4), which is let into the container base (3) and furthermore has at least one outlet (5) let into the container base (3). Through the nozzle (4), the container (1) can be supplied with compressed air and/or a cleaning compound can be pumped into the container (1).

The container (1) according to the invention is suitable for cleaning metering valves of a metering system, such as a gravimetric metering system. The container (1) is therefore a cleaning container. The container (1) has a container body (2) and a container base (3). Moreover, the container (1) has a container opening (1a). The container (1) can be mounted on the metering valve (10). Here, mounting takes place from below, from the perspective of the metering valve (10), since the metering valve generally has a downward-pointing metering head (10a), which contains the valve opening.

The container (1) preferably has a container opening (1a), which is designed in such a way that, when the container (1) is mounted on the metering valve (10), at least the head (10a) of the metering valve (10), said head containing the valve opening, is or can be surrounded in flush alignment by the container (1). Quick-acting closures, which are preferably screwable, are suitable for this purpose, for example.

The unit comprising the container body (2) and the container base (3) of the container (1) preferably has the shape of a cylinder, particularly preferably that of a cup or of a beaker.

Fundamentally, any type of material is suitable for producing the container (1), in particular the container body (2) and the container base (3). The container (1) is preferably manufactured from at least one metal or at least one alloy. To produce the container (1) and, in particular, the container body (2) and the container base (3), steel is preferably used, particularly preferably stainless steel.

The volume of the container body (2) is preferably in a range of from 100 ml to 1.5 l, particularly preferably in a range of from 150 ml to 1 l, very particularly preferably in a range of from 200 to 700 ml.

The container (1) according to the invention preferably has precisely one nozzle (4). The at least one nozzle (4) is preferably let in centrally in the center of the container base (3). By means of the nozzle (4), the container (1) can be supplied with compressed air and/or a cleaning compound can be pumped into the container (1) through said nozzle.

When mounted on the metering valve (10) to be cleaned, the container (1) according to the invention can preferably be employed at an excess pressure of up to 0.5 bar, particularly preferably of up to 0.4 bar, especially of up to 0.3 bar, when mounted on the metering valve (10) to be cleaned, i.e. the container (1) is designed in such a way that it can withstand this excess pressure.

The at least one nozzle (4) is preferably connected to a connecting element (6), which can be removed therefrom and which has both a compressed air connection (6a) and a connection (6b) for connecting a device (7) by means of which a cleaning compound can be pumped into the container (1). For this purpose, the device (7) preferably has a pump (8), e.g. a diaphragm pump. The device (7) furthermore preferably comprises at least one supply container (9), which contains the cleaning compound to be employed. By means of the pump (8), the cleaning compound can be pumped out of the supply container (9) into the container (1) for the purpose of cleaning when said container is mounted on the metering valve (10) to be cleaned.

The connecting element (6) preferably has the shape of a T-piece and can preferably be attached, particularly preferably screwed, to the nozzle (4).

By means of the compressed air connection (6a) or, alternatively, directly by means of the nozzle (4), an excess pressure can be produced in the container (1) by compressed air.

By means of the connection (6b) or, alternatively, directly by means of the nozzle (4), a cleaning compound can be pumped into the container (1).

The cleaning compound is preferably in the form of a solution, particularly preferably an aqueous solution. This solution preferably forms a rinsing solution. This solution preferably contains at least one cleaning agent. The cleaning compound employed is preferably aqueous and is suitable for cleaning contaminants of all kinds. A hybrid washing solution is preferably employed as a cleaning compound, which can remove both inorganic and organic contaminants, this having the advantage that there is no need to change the cleaning compound and cleaning is independent of the type of contaminants. A hybrid washing solution of this kind preferably contains at least one organic solvent that can be mixed with water, such as acetone, and furthermore contains water, preferably in a relative weight ratio in the range of 6:1 to 1:1, in particular 5:1 to 1.5:1 (organic solvent to water).

After use, the cleaning compound employed can be removed from the container again through the at least one, preferably precisely one, outlet (5). Removal is preferably accomplished by applying compressed air to the nozzle (4) or to the compressed air connection (6a) of the connecting element (6).

The at least one outlet (5) is preferably closable. The outlet (5) is preferably connected to a check valve (5a).

Use According to the Invention

A further subject of the present invention is a use of the container (1) according to the invention for cleaning metering valves of a metering system.

All the preferred embodiments described hereinabove in connection with the container (1) according to the invention are also preferred embodiments in respect of the use according to the invention of the container (1) according to the invention.

The use according to the invention is preferably performed in such a way that cleaning is performed by means of at least one cleaning compound and/or by means of compressed air, particularly preferably both by means of at least one cleaning compound and by means of compressed air one after the other.

Metering Valve (10) According to the Invention

A further subject of the present invention is a metering valve (10), on which a container (1) according to the invention for cleaning the metering valve is mounted.

All the preferred embodiments described hereinabove in connection with the container (1) according to the invention and the use according to the invention are also preferred embodiments in respect of the metering valve according to the invention.

The metering valve (10) can be pivotable or non-pivotable. Furthermore, the metering valve can be part of a mobile metering station or part of a metering system, such as a gravimetric metering system.

The metering valve (10) is preferably a fine and coarse flow valve, i.e. is capable both of metering fine flows and coarse flows.

Metering System According to the Invention

A further subject of the present invention is a metering system comprising at least one metering valve (10), on which a container (1) according to the invention for cleaning the metering valve is mounted.

All the preferred embodiments described hereinabove in connection with the container (1) according to the invention and the use according to the invention and the metering valve (10) according to the invention are also preferred embodiments in respect of the metering system according to the invention.

The metering system according to the invention is preferably a gravimetric metering system.

Method According to the Invention

A further subject of the present invention is a method for cleaning metering valves of a metering system, wherein the method comprises at least one step (1), namely
(1) cleaning at least one metering valve of a metering system using at least one container (1) according to the invention.

All the preferred embodiments described hereinabove in connection with the container (1) according to the invention and the use according to the invention and the metering valve (10) according to the invention and the metering system according to the invention are also preferred embodiments in respect of the method according to the invention.

Before the method according to the invention is carried out, the container (1) is mounted on the metering valve.

Cleaning is preferably performed by means of at least one cleaning compound and/or by means of compressed air. As a particular preference, cleaning in accordance with step (1) is performed both by means of at least one cleaning compound and by means of compressed air.

Cleaning in accordance with step (1) is preferably performed in at least two stages comprising stages (1a) and (1b) in this sequence, namely by
(1a) cleaning the at least one metering valve, using the container (1), by means of at least one cleaning compound, and
(1b) cleaning the at least one metering valve, using the container (1), by means of compressed air.

Cleaning by means of at least one cleaning compound makes it possible to dissolve contaminants adhering to and/or in the metering valve (10), in particular to and/or in the head (10a) of the metering valve (10).

Within stage (1a), at least one cleaning compound is preferably pumped into the container (1) by means of a pump (8). The cleaning compound preferably comes from the supply container (9).

Cleaning by means of compressed air allows drying of the metering valve (10) and, in particular, of the head (10a) of the metering valve (10). This prevents residues of the cleaning compound employed that adhere in/to the metering valve (10) or in/to the head (10a) of the metering valve (10) after cleaning by means of at least one cleaning compound from being able to fall into the container into which metering is being performed during the subsequent use of the metering valve in metering. Moreover, cleaning by means of compressed air after prior cleaning by means of at least one cleaning compound enables residues of the cleaning compound remaining within the container (1) and/or contaminants stemming from the metering valve (10) or from the head (10a) of the metering valve (10) from being transferred out of the container (1) into a collecting container (11) by means of the outlet (5) or, alternatively, from being transferred back into the supply container (9) which contains the cleaning compound employed.

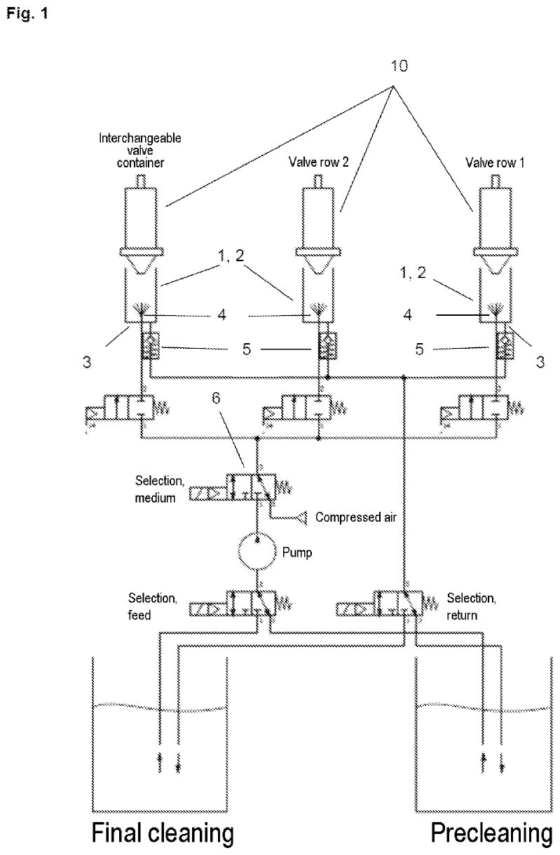

FIG. 1 shows a flow diagram of the method for valve cleaning for a metering valve, which makes use of the container (1) according to the invention. In respect of cleaning, two operating modes are possible here: on the one hand, it is possible, as illustrated in FIG. 1, for each of the two cleaning containers to be operated separately as a ring line. Then operations are carried out with one supply container for precleaning and with another supply container for final cleaning. As an alternative, however, it is also possible for just one cleaning container to be used as a supply container for the cleaning compound and for the contaminated rinsing solution to be collected in another, initially empty container. In this operating mode, each valve is thus only ever cleaned with a “fresh”, i.e. uncontaminated, cleaning compound. There is no cross transfer of contaminants to/into the metering valves.

1. A container suitable for cleaning metering valves of a metering system, wherein the container can be mounted on a metering valve and comprises a container body and a container base,
wherein the container has in its interior at least one nozzle, which is let into the container base, through which the container can be supplied with compressed air and/or through which a cleaning compound can be pumped into the container, wherein the at least one nozzle is connected to a connecting element, which can be removed therefrom and which has both a compressed air connection and a connection for connecting a device by means of which a cleaning compound can be pumped into the container,
wherein the container has at least one outlet let into the container base, and the container has a container opening, which is designed in such a way that, when the container is mounted on the metering valve, at least a head of the metering valve, the head containing a valve opening, is surrounded in flush alignment by the container.

2. The container as claimed in claim 1, wherein a unit comprising the container body and the container base of the container has the shape of a cylinder.

3. The container as claimed in claim 1, wherein the at least one nozzle is let in centrally in a center of the container base.

4. The container as claimed in claim 1, wherein the connecting element has the shape of a T-piece.

5. The container as claimed in claim 1, wherein the container can be employed at an excess pressure of up to 0.5 bar in the state in which it is mounted on the metering valve.

6. The container as claimed in claim 1, wherein the container is manufactured from metal or from an alloy.

7. The container as claimed in claim 1, wherein the at least one outlet is closable.

8. A method of using the container as claimed in claim 1, the method comprising using the container for cleaning metering valves of a metering system.

9. The method as claimed in claim 8, wherein the cleaning is performed by means of at least one cleaning compound and/or by means of compressed air.

10. A metering valve, on which a container for cleaning the metering valve is mounted, wherein the container as claimed in claim 1 is employed as the container.

11. A metering system comprising at least one metering valve, on which a container for cleaning the metering valve is mounted, wherein the container as claimed in claim 1 is employed as the container.

12. A method for cleaning metering valves of a metering system, the method comprising:
(1) cleaning at least one metering valve of the metering system using at least one container as claimed in claim 1.

13. The method as claimed in claim 12, wherein the cleaning is performed in by means of at least one cleaning compound and/or by means of compressed air.

14. The method as claimed in claim 12, wherein the cleaning is performed in at least two stages comprising:
(1a) cleaning the at least one metering valve, using the container, by means of at least one cleaning compound, and
(1b) cleaning the at least one metering valve, using the container, by means of compressed air.

15. The method as claimed in claim 14, wherein, within stage, at least one cleaning compound is pumped into the container by means of a pump.
